(19) United States
(12) Patent Application Publication
(10) Pub. No.: US 2025/0260035 A1
(43) Pub. Date: Aug. 14, 2025

(54) FUEL CELL SYSTEM

(71) Applicant: Honda Motor Co., Ltd., Tokyo (JP)

(72) Inventors: Kousuke Matsui, Saitama (JP); Masao Utsunomiya, Saitama (JP)

(21) Appl. No.: 19/045,474

(22) Filed: Feb. 4, 2025

(30) Foreign Application Priority Data
Feb. 8, 2024 (JP) 2024-017669

(51) Int. Cl. H01M 8/04858; B60L 50/70; H01M 8/0432; H01M 8/0438

(52) U.S. Cl. CPC H01M 8/0491; B60L 50/70; H01M 8/04335; H01M 8/04395

(57) ABSTRACT

Fuel cell system includes: fuel cell stack including anode flow path through which fuel gas containing hydrogen flows and cathode flow path through which oxidant gas containing oxygen flows; fuel gas supply unit supplying fuel gas to anode flow path; oxidant gas supply unit supplying oxidant gas to cathode flow path; detection unit detecting oxygen partial pressure of oxidant gas flowing through cathode flow path or oxygen partial pressure representative value that is physical quantity having correlation with oxygen partial pressure; current limiting circuit limiting output current from fuel cell stack to limit value or less; and ECU controlling current limiting circuit. ECU controls current limiting circuit to limit output current when oxygen partial pressure becomes equal to or less than predetermined pressure based on oxygen partial pressure or oxygen partial pressure representative value detected by detection unit.

### CROSS-REFERENCE TO RELATED APPLICATION

This application is based upon and claims the benefit of priority from Japanese Patent Application No. 2024-017669 filed on Feb. 8, 2024, the content of which is incorporated herein by reference.

### BACKGROUND OF THE INVENTION

### Field of the Invention

The present invention relates to a fuel cell system.

### Description of the Related Art

Use of a fuel cell as a drive source of a vehicle or the like can contribute to improvement of energy efficiency. As a technique related to such a fuel cell, a device that limits an output current from a fuel cell stack is conventionally known. For example, in the device described in JP 2015-228305 A, a delay time of air from a flow rate sensor to the fuel cell is calculated on the basis of a volume flow rate of the air, the volume flow rate of the air in the fuel cell is calculated on the basis of the volume flow rate of the air and the delay time, and the generated current of the fuel cell is limited so as to be a generated current corresponding to the volume flow rate of the air in the fuel cell. Incidentally, when the internal temperature of the fuel cell stack becomes high, a partial pressure of water vapor in the oxidant gas (air) increases, and a partial pressure of oxygen decreases. Therefore, simply limiting the output current in accordance with the flow rate of air, as in the device described in JP 2015-228305 A, may result in a drop in output voltage from the stack when the internal temperature of the fuel cell stack becomes high.

### SUMMARY OF THE INVENTION

An aspect of the present invention is a fuel cell system including: a fuel cell stack including an anode flow path through which fuel gas containing hydrogen flows and a cathode flow path through which oxidant gas containing oxygen flows; a fuel gas supply unit configured to supply the fuel gas to the anode flow path; an oxidant gas supply unit configured to supply the oxidant gas to the cathode flow path; an oxygen partial pressure detection unit configured to detect an oxygen partial pressure of the oxidant gas flowing through the cathode flow path or an oxygen partial pressure representative value that is a physical quantity having a correlation with the oxygen partial pressure; a current limiting circuit configured to limit an output current output from the fuel cell stack to a limit value or less; and an electronic control unit configured to control the current limiting circuit.

The electronic control unit controls the current limiting circuit to limit the output current when the oxygen partial pressure becomes equal to or less than a predetermined pressure based on the oxygen partial pressure or the oxygen partial pressure representative value detected by the oxygen partial pressure detection unit.

### BRIEF DESCRIPTION OF THE DRAWINGS

The objects, features, and advantages of the present invention will become clearer from the following description of embodiments in relation to the attached drawings, in which:

FIG. 1 is a diagram schematically illustrating an example of an overall configuration of a fuel cell system according to an embodiment of the present invention;

FIG. 2 is a block diagram schematically illustrating an example of a control configuration of the fuel cell system according to the embodiment of the present invention;

FIG. 3 is a diagram for explaining relationship between cathode flow rate in a cathode flow path in FIG. 1 and decrease in output voltage of the fuel cell stack;

FIG. 4 is a diagram for explaining relationship between cathode oxygen partial pressure in the cathode flow path in FIG. 1 and the decrease in the output voltage of the fuel cell stack;

FIG. 5 is a diagram for explaining characteristic of a limit value set by a current limitation unit in FIG. 2;

FIG. 6A is a flowchart illustrating an example of processing executed by an electronic control unit in FIG. 2; and

FIG. 6B is a flowchart illustrating another example of processing executed by the electronic control unit in FIG. 2.

### DETAILED DESCRIPTION OF THE INVENTION

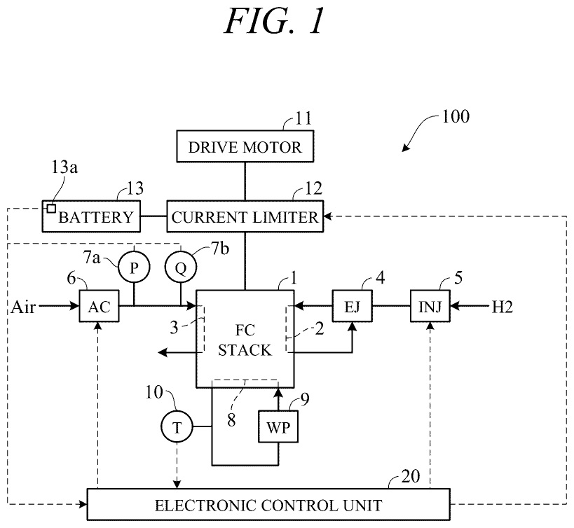

Hereinafter, an embodiment of the present invention will be described with reference to FIGS. 1 to 6B. FIG. 1 is a diagram schematically illustrating an example of an overall configuration of a fuel cell system 100 according to an embodiment of the present invention. As illustrated in FIG. 1, the fuel cell system 100 mainly includes a fuel cell stack 1 formed by stacking power generation cells each having a solid polymer electrolyte membrane, and an electronic control unit 20 that controls each unit of the fuel cell system 100. The fuel cell system 100 is mounted on a vehicle, for example, and can generate electric power for driving the vehicle. The fuel cell system 100 can be mounted on a moving body, such as an aircraft or a ship, other than a vehicle, a robot, or various types of industrial machine.

The fuel cell stack 1 is provided with an anode flow path 2 through which a fuel gas containing hydrogen flows, and a cathode flow path 3 through which an oxidant gas such as air containing oxygen flows. The fuel gas is supplied to an anode electrode of each power generation cell of the fuel cell stack 1 through the anode flow path 2, and the oxidant gas is supplied to a cathode electrode through the cathode flow path 3. Accordingly, an electrochemical reaction proceeds in the electrode of each power generation cell, and power generation is performed in the fuel cell stack 1.

A fuel gas tank storing high-pressure fuel gas is connected to the anode flow path 2 via an ejector 4 and an injector 5, and the fuel gas in the fuel gas tank is supplied to the anode flow path 2 by the injector 5. The fuel gas supplied to the anode flow path 2 by the injector 5 is partially used in the anode electrode, and then discharged from the anode flow path 2 as a fuel exhaust gas. The fuel exhaust gas discharged from the anode flow path 2 is sucked through the ejector 4 after water is separated through a gas-liquid separator (not illustrated), and is supplied to the anode flow path 2 again.

An air compressor 6 for supplying an oxidant gas is connected to the cathode flow path 3, and the oxidant gas compressed by the air compressor 6 is supplied to the cathode flow path 3. The oxidant gas supplied to the cathode flow path 3 is partially used in the cathode electrode, and then discharged from the cathode flow path 3 to the outside as an oxidant exhaust gas. A cathode pressure sensor 7a and a cathode flow rate sensor 7b are provided in a pipe connecting the inlet of the cathode flow path 3 and the air compressor 6. The cathode pressure sensor 7a detects a pressure (cathode pressure) P of the oxidant gas supplied to the cathode flow path 3 by the air compressor 6. The cathode flow rate sensor 7b detects a flow rate (cathode flow rate) Q of the oxidant gas supplied to the cathode flow path 3 by the air compressor 6. The cathode flow rate Q is, for example, a mass flow rate.

A cooling flow path 8 through which a cooling medium circulates is also provided inside the fuel cell stack 1. A water pump 9 that circulates the cooling medium through a radiator (not illustrated) is connected to the cooling flow path 8. In the pipe connecting the cooling flow path 8 and the water pump 9, a stack temperature sensor 10 is provided near the outlet of the cooling flow path 8, and detects the temperature of the cooling medium discharged from the cooling flow path 8. The temperature of the cooling medium discharged from cooling flow path 8 represents the overall internal temperature (stack temperature) of the fuel cell stack 1, and represents a temperature (cathode temperature) T of the oxidant gas flowing through the cathode flow path 3. The stack temperature sensor 10 detects the cathode temperature T by using the temperature of the cooling medium discharged from the cooling flow path 8.

The fuel cell stack 1 is electrically connected to a drive motor (motor generator) 11 via metal terminal plates sandwiching the stacked body of the power generation cells. A current limiter (current limiting circuit) 12 is interposed between the fuel cell stack 1 and the drive motor 11, and the electric power generated by the fuel cell stack 1 is supplied to the drive motor 11 via the current limiter 12. The current limiter 12 limits a magnitude (current value) of an output current output from fuel cell stack 1 to a predetermined limit value or less.

A battery 13 can be electrically connected to the current limiter 12 via a DC/DC converter (not illustrated). In this case, a part or all of the electric power generated by the fuel cell stack 1 can be stored in the battery 13 through the current limiter 12. In addition, the electric energy generated by the drive motor 11 for vehicle traveling at the time of regenerative braking of the vehicle can be stored in the battery 13 via the current limiter 12. In addition, the electric power stored in the battery 13 can be supplied to the drive motor 11 via the current limiter 12 as necessary. The battery 13 is provided with a battery voltage sensor 13a that detects a voltage (battery voltage) of the battery 13. A state of charge (SOC) of the battery 13 can be estimated on the basis of the battery voltage detected by the battery voltage sensor 13a.

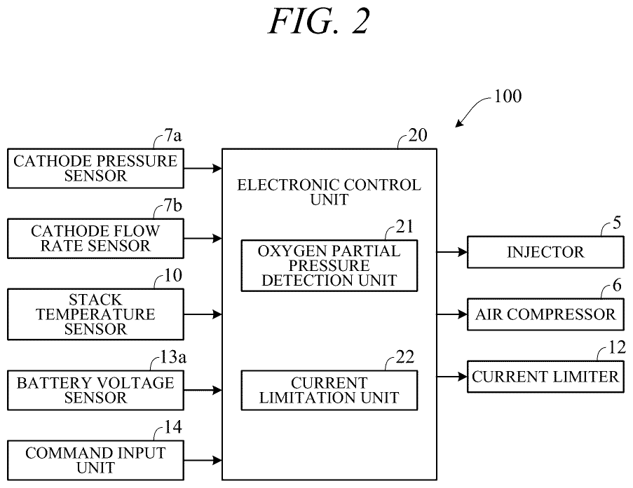

FIG. 2 is a block diagram schematically illustrating an example of a control configuration of the fuel cell system 100. The electronic control unit 20 of the fuel cell system 100 includes a computer having a CPU, a RAM, a ROM, an I/O interface, and other peripheral circuits. As illustrated in FIGS. 1 and 2, sensors such as the cathode pressure sensor 7a, the cathode flow rate sensor 7b, the stack temperature sensor 10, and the battery voltage sensor 13a are connected to the electronic control unit 20, and a detection value is input from each sensor to the electronic control unit 20. In addition, each unit of the fuel cell system 100 such as the injector 5, the air compressor 6, and the current limiter 12 is connected to the electronic control unit 20, and the electronic control unit 20 controls each unit of the fuel cell system 100.

As illustrated in FIG. 2, the electronic control unit 20 is also connected to a command input unit 14 that inputs various commands such as activation and request output of the fuel cell system 100. The command input unit 14 includes, for example, an ignition switch, an accelerator opening sensor, and the like of a vehicle using the drive motor 11 as a traveling drive source. When a start command of the fuel cell system 100 is input from the command input unit 14, the electronic control unit 20 controls the injector 5 and the air compressor 6 to supply the fuel gas and the oxidant gas to the fuel cell stack 1 so that fuel cell stack 1 generates power. In addition, the electronic control unit 20 calculates the flow rates of the fuel gas and the oxidant gas to be supplied to the fuel cell stack 1 on the basis of the detection value of each sensor and the request output input from the command input unit 14, and controls the injector 5 and the air compressor 6 according to the calculation result. In addition, the electronic control unit 20 calculates a limit value of the output current from the fuel cell stack 1 on the basis of the detection value of each sensor, and controls the current limiter 12 according to the calculation result.

As illustrated in FIG. 2, the electronic control unit 20 includes an oxygen partial pressure detection unit 21 and a current limitation unit 22 as functional configurations, and functions as an oxygen partial pressure detection unit 21 and a current limitation unit 22.

During normal rated operation (normal operation) of the fuel cell stack 1, the stack temperature and the cathode temperature T are in a temperature range from a room temperature to a predetermined temperature Tα higher than the room temperature. However, in a case where an outside air temperature is high, a case where an operation at a high load (high output) is performed for a long period of time, or the like, the stack temperature and the cathode temperature T may rise and become equal to or higher than the predetermined temperature Tα (high-temperature operation). In the high-temperature operation, the water vapor partial pressure (cathode water vapor partial pressure) PH₂O of the oxidant gas flowing through the cathode flow path 3 increases as the cathode temperature T rises, the oxygen partial pressure (cathode oxygen partial pressure) PO₂ decreases accordingly, and the oxygen concentration at the interface of the cathode electrode decreases.

When the cathode oxygen partial pressure PO₂ decreases, even if an amount of oxidant gas necessary for power generation (electrochemical reaction) in the fuel cell stack 1 is supplied to the cathode flow path 3, an oxygen concentration at the interface of the cathode electrode decreases, and the concentration may be lower than the concentration necessary for power generation. In this case, in order to maintain the current value, it is necessary to increase a probability that electrons are exchanged between the cathode electrode and oxygen by consuming a voltage (concentration overvoltage), and the output voltage is lower than the reference IV characteristic during the normal operation, and a power generation state becomes unstable.

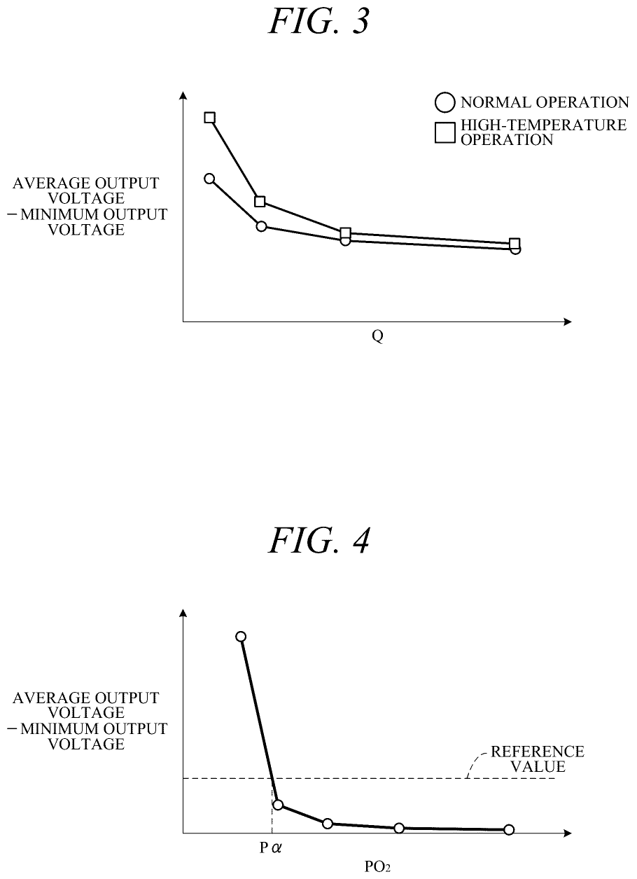

FIG. 3 is a diagram for explaining a relationship between the cathode flow rate Q and a decrease in the output voltage of the fuel cell stack 1, and illustrates a difference between an average value (average output voltage) and a minimum value (minimum output voltage) of the output voltage of the fuel cell stack 1 during the normal operation and the high-temperature operation. As illustrated in FIG. 3, the difference between the average output voltage and the minimum output voltage, that is, the decrease in the output voltage of the fuel cell stack 1 is larger during the high-temperature operation than during the normal operation, and the power generation state becomes more unstable during the high-temperature operation than during the normal operation. In addition, on the lower flow rate side where cathode flow rate Q is smaller, the output voltage of the fuel cell stack 1 decreases further, and the power generation state becomes unstable.

FIG. 4 is a diagram for explaining a relationship between the cathode oxygen partial pressure PO₂ and the decrease in the output voltage of the fuel cell stack 1. As illustrated in FIG. 4, the decrease in the output voltage of the fuel cell stack 1 is greater when the cathode oxygen partial pressure PO₂ is lower, and the power generation state becomes unstable. The cathode oxygen partial pressure PO₂ can be calculated and estimated on the basis of the cathode pressure P, the cathode flow rate Q, and the cathode temperature T. That is, the cathode water vapor partial pressure PH₂O is calculated as the saturated water vapor pressure corresponding to the cathode temperature T, and the partial pressure (PO₂+PN₂) of oxygen and nitrogen contained in the oxidant gas flowing through the cathode flow path 3 is calculated by subtracting the cathode water vapor partial pressure PH₂O from the cathode pressure P. The characteristics of the saturated water vapor pressure with respect to the temperature or the temperature range are stored in advance in the electronic control unit 20 (ROM). The calculated partial pressure (PO₂+PN₂) of oxygen and nitrogen is multiplied by an air stoichiometric ratio corresponding to the cathode flow rate Q to calculate the cathode oxygen partial pressure PO₂. The air stoichiometric ratio is a ratio of an amount of oxygen consumed by power generation (electrochemical reaction) in the fuel cell stack 1 to an amount of oxidant gas (oxygen and nitrogen) supplied, and can be calculated on the basis of a current value and the cathode flow rate Q. When the cathode oxygen partial pressure PO₂ becomes equal to or less than a predetermined pressure Pα, the decrease in the output voltage of the fuel cell stack 1 becomes equal to or more than a reference value, and the power generation state becomes unacceptably unstable.

The oxygen partial pressure detection unit 21 detects the cathode temperature T, the cathode pressure P, and the cathode flow rate Q (oxygen partial pressure representative value), which are physical quantities having a correlation with the cathode oxygen partial pressure PO₂ or the cathode oxygen partial pressure PO₂. More specifically, the cathode oxygen partial pressure PO₂ is calculated on the basis of the cathode pressure P detected by the cathode pressure sensor 7a, the cathode flow rate Q detected by the cathode flow rate sensor 7b, and the cathode temperature T detected by the stack temperature sensor 10, thereby detecting the cathode oxygen partial pressure PO₂. In this case, the cathode water vapor partial pressure PH₂O is calculated on the basis of the cathode temperature T detected by the stack temperature sensor 10, and the cathode oxygen partial pressure PO₂ is calculated on the basis of the calculated cathode water vapor partial pressure PH₂O, the cathode pressure P detected by the cathode pressure sensor 7a, and the cathode flow rate Q detected by the cathode flow rate sensor 7b. Alternatively, the oxygen partial pressure detection unit 21 detects, as oxygen partial pressure representative values, the cathode pressure P, the cathode flow rate Q, and the cathode temperature T on the basis of signals from the cathode pressure sensor 7a, the cathode flow rate sensor 7b, and the stack temperature sensor 10.

When the cathode oxygen partial pressure PO₂ detected by the oxygen partial pressure detection unit 21 becomes equal to or less than the predetermined pressure Pa, the current limitation unit 22 controls the current limiter 12 so that the output current output from the fuel cell stack 1 becomes equal to or less than the limit value, and performs the output current limitation for limiting the output current.

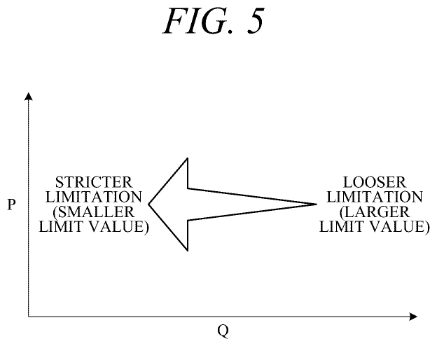

FIG. 5 is a diagram for explaining a characteristic (characteristic map) of the limit value set by the current limitation unit 22, and illustrates a predetermined characteristic representing a relationship among the cathode pressure P, the cathode flow rate Q, the cathode temperature T, and the limit value. The characteristic of such a limit value is determined in advance by a test and stored in the electronic control unit 20 (ROM). The characteristic of the limit value is a characteristic of the limit value with respect to the cathode pressure P and the cathode flow rate Q determined corresponding to each of a plurality of temperature ranges of the cathode temperature T. The plurality of temperature ranges of the cathode temperature T include, for example, a temperature range lower than the predetermined temperature Tα corresponding to the temperature range during the normal operation and a temperature range equal to or higher than the predetermined temperature Tα corresponding to the temperature range during the high-temperature operation. The temperature range during the high-temperature operation may further include a plurality of temperature ranges (for example, a first temperature range of Tα or more and less than Tβ and a second temperature range of Tβ or more). The limit value is set as a smaller current value as the cathode temperature T is in a higher temperature range (that is, the stricter output current limitation is set to be performed in a temperature range in which the cathode temperature T is higher).

In a case where output current limitation is performed on the basis of the oxygen partial pressure representative value, the current limitation unit 22 first selects a temperature range to which the cathode temperature T belongs on the basis of the cathode temperature T detected by the stack temperature sensor 10. The selection of the temperature range by the current limitation unit 22 may be performed in real time according to a detection cycle of the cathode temperature T by the stack temperature sensor 10, or may be performed every predetermined period longer than the detection cycle. In a case where the selection of the temperature range by the current limitation unit 22 is performed every predetermined period longer than the detection cycle, the temperature range may be selected on the basis of the latest detection value of the cathode temperature T, or the temperature range may be selected on the basis of the average value or the maximum value of the predetermined period. In this case, the frequency of switching the characteristic map due to the change in the temperature range can be suppressed, and the calculation load of the electronic control unit 20 can be suppressed.

As illustrated in FIG. 5, the limit value is set as a smaller current value as the cathode flow rate Q is smaller and the cathode oxygen partial pressure PO₂ is lower (that is, the stricter output current limitation is set to be performed as the cathode flow rate Q is smaller and the cathode oxygen partial pressure PO₂ is lower). The current limitation unit 22 sets a limit value on the basis of the characteristic map corresponding to the temperature range selected on the basis of the cathode temperature T, the cathode pressure P detected by the cathode pressure sensor 7a, and the cathode flow rate Q detected by the cathode flow rate sensor 7b. When the limit value is set, the current limitation unit 22 controls the current limiter 12 such that the output current output from fuel cell stack 1 becomes equal to or less than the limit value, thereby performing the output current limitation.

During the output current limitation by the current limitation unit 22, the request output input from the command input unit 14 may not be satisfied. In this case, the electric power from the battery 13 may be supplied to the drive motor 11 on condition that the SOC based on the battery voltage detected by the battery voltage sensor 13a is equal to or larger than a predetermined threshold.

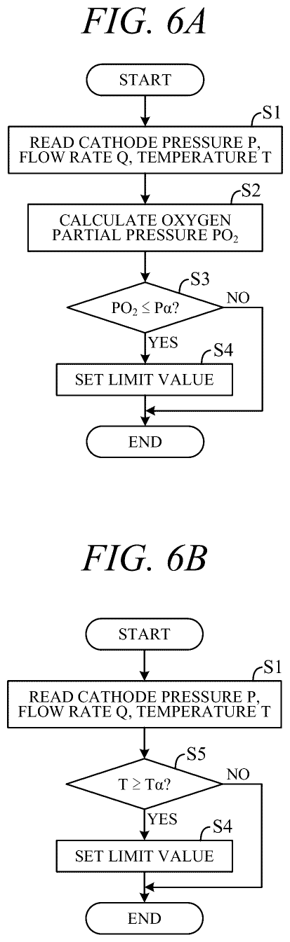

FIGS. 6A and 6B are flowcharts illustrating an example of processing executed by the electronic control unit 20. The processing starts when a start command of the fuel cell system 100 is input from the command input unit 14, and is repeated at a predetermined cycle.

In the example of FIG. 6A, first, in S1 (S: processing step), the cathode pressure P detected by the cathode pressure sensor 7a, the cathode flow rate Q detected by the cathode flow rate sensor 7b, and the cathode temperature T detected by the stack temperature sensor 10 are read. Next, in S2, the cathode oxygen partial pressure PO₂ is calculated on the basis of the cathode pressure P, the cathode flow rate Q, and the cathode temperature T read in S1. Next, in S3, it is determined whether or not the cathode oxygen partial pressure PO₂ calculated in S2 is equal to or less than the predetermined pressure Pα. When an affirmative determination is made in S3, the processing proceeds to S4 to set the limit value and perform the output current limitation. On the other hand, when a negative determination is made in S3, the processing ends without performing the output current limitation.

In the example of FIG. 6B, first, in S1, the cathode pressure P detected by the cathode pressure sensor 7a, the cathode flow rate Q detected by the cathode flow rate sensor 7b, and the cathode temperature T detected by the stack temperature sensor 10 are read. Next, in S5, it is determined whether or not the cathode temperature T read in S1 is equal to or higher than the predetermined temperature Tα. When an affirmative determination is made in S5, the processing proceeds to S4, and on the basis of the cathode pressure P, the cathode flow rate Q, and the cathode temperature T read in S1, and the predetermined characteristic in FIG. 5, the limit value is set, and the output current limitation is performed. On the other hand, when a negative determination is made in S5, the processing ends without performing the output current limitation.

According to the present embodiment, the following operations and effects can be achieved.
(1) The fuel cell system 100 includes: the fuel cell stack 1 that is provided with the anode flow path 2 through which a fuel gas containing hydrogen flows and the cathode flow path 3 through which an oxidant gas containing oxygen flows; the injector 5 that supplies the fuel gas to the anode flow path 2; the air compressor 6 that supplies the oxidant gas to the cathode flow path 3; the oxygen partial pressure detection unit 21 that detects an oxygen partial pressure representative value (cathode temperature T, cathode pressure P, cathode flow rate Q), which is a physical quantity having a correlation with the oxygen partial pressure (cathode oxygen partial pressure) PO₂ or the cathode oxygen partial pressure PO₂ of the oxidant gas flowing through the cathode flow path 3, and the current limitation unit 22 that limits an output current output from the fuel cell stack 1 so that the output current becomes equal to or less than a limit value when the cathode oxygen partial pressure PO₂ becomes equal to or less than the predetermined pressure Pα, on the basis of the cathode oxygen partial pressure PO₂ or the oxygen partial pressure representative value detected by the oxygen partial pressure detection unit 21 (FIGS. 1, 2, 4, 6A, and 6B). When the cathode oxygen partial pressure PO₂ becomes equal to or less than the predetermined pressure Pα, the output current from the fuel cell stack 1 is limited, so that the decrease in the output voltage can be suppressed even if the internal temperature of the fuel cell stack 1 becomes high.
(2) The fuel cell system 100 further includes: the cathode pressure sensor 7a that detects the pressure (cathode pressure) P of the oxidant gas supplied by the air compressor 6; the cathode flow rate sensor 7b that detects the flow rate (cathode flow rate) Q of the oxidant gas supplied by the air compressor 6; and the stack temperature sensor 10 that detects a temperature of the oxidant gas flowing through the cathode flow path 3 or the cathode temperature T that is a temperature having a correlation with such a temperature (FIGS. 1 and 2).
(3) The oxygen partial pressure detection unit 21 detects the cathode oxygen partial pressure PO₂ by calculating the cathode oxygen partial pressure PO₂ on the basis of the cathode pressure P detected by the cathode pressure sensor 7a, the cathode flow rate Q detected by the cathode flow rate sensor 7b, and the cathode temperature T detected by the stack temperature sensor 10 (S2 in FIG. 6A). Accordingly, the cathode oxygen partial pressure PO₂ can be accurately detected with a simple configuration.
(4) The oxygen partial pressure detection unit 21 calculates the water vapor partial pressure (cathode water vapor partial pressure) PH₂O of the oxidant gas flowing through the cathode flow path 3 on the basis of the cathode temperature T detected by the stack temperature sensor 10, and calculates the cathode oxygen partial pressure PO₂ on the basis of the calculated cathode water vapor partial pressure PH₂O, the cathode pressure P detected by the cathode pressure sensor 7a, and the cathode flow rate Q detected by the cathode flow rate sensor 7b (S2 in FIG. 6A). Accordingly, the cathode oxygen partial pressure PO₂ during high-temperature operation of the fuel cell stack 1 can be appropriately calculated.
(5) The oxygen partial pressure detection unit 21 detects the cathode pressure P, the cathode flow rate Q, and the cathode temperature T as oxygen partial pressure representative values (S1 in FIG. 6B). The current limitation unit 22 sets a limit value on the basis of a predetermined characteristic representing a relationship among the cathode pressure P, the cathode flow rate Q, the cathode temperature T, and the limit value, the cathode pressure P detected by the cathode pressure sensor 7a, the cathode flow rate Q detected by the cathode flow rate sensor 7b, and the cathode temperature T detected by the stack temperature sensor 10. Accordingly, the oxygen partial pressure representative value can be accurately detected with a simple configuration, and the limit value can be set so as to perform output current limitation when the cathode oxygen partial pressure PO₂ corresponding to the detected oxygen partial pressure representative value becomes equal to or less than the predetermined pressure Pα.
(6) The predetermined characteristic is a characteristic of the limit value with respect to the cathode pressure P and the cathode flow rate Q determined in advance corresponding to each of a plurality of temperature ranges of the cathode temperature T (FIG. 5). For example, the output current limitation is not performed in a temperature range (less than predetermined temperature Tα) during the normal operation of the fuel cell stack 1, and the output current limitation is performed in a temperature range (equal to or higher than the predetermined temperature Tα) during the high-temperature operation. Accordingly, it is possible to limit the output current from the fuel cell stack 1 during the high-temperature operation in which a probability that the output voltage decreases due to the decrease in the cathode oxygen partial pressure PO₂ is high, and to suppress the decrease in the output voltage.
(7) On the basis of the cathode temperature T detected by the stack temperature sensor 10, the current limitation unit 22 sets the limit value to be smaller as the cathode temperature T is higher (FIG. 5). Accordingly, the stricter output current limitation can be performed during the high-temperature operation in which the probability that the output voltage decreases due to the decrease in the cathode oxygen partial pressure PO₂ is high.
(8) On the basis of the cathode oxygen partial pressure PO₂ or the oxygen partial pressure representative value (cathode temperature T, cathode pressure P, cathode flow rate Q) detected by the oxygen partial pressure detection unit 21, the current limitation unit 22 sets the limit value to be smaller as the cathode oxygen partial pressure PO₂ is lower (S4 in FIGS. 6A and 6B). Accordingly, the stricter output current limitation can be performed during an operation under conditions that the cathode oxygen partial pressure PO₂ is low and a probability that the output voltage decreases is high.

In the above embodiment, an example in which a temperature of a cooling medium discharged from the cooling flow path 8 is detected as the cathode temperature T has been described with reference to FIG. 1 and the like, but a temperature detection unit that detects the cathode temperature is not limited to such an example. For example, a temperature of an oxidant exhaust gas discharged from cathode flow path 3 may be detected as the physical quantity representing the cathode temperature, or a temperature of the fuel cell stack 1 itself (for example, each power generation cell) may be detected.

In the above embodiment, an example in which the characteristic map determined for each temperature range of the cathode temperature T is used to set the limit value has been described with reference to FIG. 5 and the like, but a characteristic for setting a limit value when limiting the output current is not limited to such a characteristic. For example, the characteristic may be determined for each range of the cathode pressure or may be determined for each range of the cathode flow rate.

The above embodiment can be combined as desired with one or more of the aforesaid modifications. The modifications can also be combined with one another.

According to the present invention, it becomes possible to suppress decrease in the output voltage even if the internal temperature of the fuel cell stack becomes high.

Above, while the present invention has been described with reference to the preferred embodiments thereof, it will be understood, by those skilled in the art, that various changes and modifications may be made thereto without departing from the scope of the appended claims.

1. A fuel cell system, comprising:
a fuel cell stack including an anode flow path through which fuel gas containing hydrogen flows and a cathode flow path through which oxidant gas containing oxygen flows;
a fuel gas supply unit configured to supply the fuel gas to the anode flow path;
an oxidant gas supply unit configured to supply the oxidant gas to the cathode flow path;
an oxygen partial pressure detection unit configured to detect an oxygen partial pressure of the oxidant gas flowing through the cathode flow path or an oxygen partial pressure representative value that is a physical quantity having a correlation with the oxygen partial pressure;
a current limiting circuit configured to limit an output current output from the fuel cell stack to a limit value or less; and
an electronic control unit configured to control the current limiting circuit, wherein
the electronic control unit controls the current limiting circuit to limit the output current when the oxygen partial pressure becomes equal to or less than a predetermined pressure based on the oxygen partial pressure or the oxygen partial pressure representative value detected by the oxygen partial pressure detection unit.

2. The fuel cell system according to claim 1, further comprising:
a pressure sensor configured to detect an oxidant gas pressure of the oxidant gas supplied by the oxidant gas supply unit;
a flow rate sensor configured to detect an oxidant gas flow rate of the oxidant gas supplied by the oxidant gas supply unit; and
a temperature sensor configured to detect an oxidant gas temperature of the oxidant gas flowing through the cathode flow path or a cathode temperature that is a temperature having a correlation with the oxidant gas temperature, wherein
the oxygen partial pressure detection unit detects the oxygen partial pressure by calculating the oxygen partial pressure based on the oxidant gas pressure detected by the pressure sensor, the oxidant gas flow rate detected by the flow rate sensor, and the cathode temperature detected by the temperature sensor, or detects the oxidant gas pressure, the oxidant gas flow rate, and the cathode temperature as the oxygen partial pressure representative value.

3. The fuel cell system according to claim 2, wherein
the oxygen partial pressure detection unit detects the oxygen partial pressure by calculating the oxygen partial pressure based on the oxidant gas pressure detected by the pressure sensor, the oxidant gas flow rate detected by the flow rate sensor, and the cathode temperature detected by the temperature sensor.

4. The fuel cell system according to claim 3, wherein
the oxygen partial pressure detection unit calculates a water vapor partial pressure of the oxidant gas flowing through the cathode flow path based on the cathode temperature detected by the temperature sensor, and calculates the oxygen partial pressure based on the water vapor partial pressure calculated, the oxidant gas pressure detected by the pressure sensor, and the oxidant gas flow rate detected by the flow rate sensor.

5. The fuel cell system according to claim 2, wherein
the oxygen partial pressure detection unit detects the oxidant gas pressure, the oxidant gas flow rate, and the cathode temperature as the oxygen partial pressure representative value, wherein
the electronic control unit sets the limit value based on: a predetermined characteristic representing a relationship among the oxidant gas pressure, the oxidant gas flow rate, the cathode temperature, and the limit value; the oxidant gas pressure detected by the pressure sensor; the oxidant gas flow rate detected by the flow rate sensor; and the cathode temperature detected by the temperature sensor.

6. The fuel cell system according to claim 5, wherein
the predetermined characteristic is a characteristic of the limit value with respect to the oxidant gas pressure and the oxidant gas flow rate determined in advance corresponding to each of a plurality of temperature ranges of the cathode temperature.

7. The fuel cell system according to claim 2, wherein
the electronic control unit sets the limit value to be smaller as the cathode temperature is higher based on the cathode temperature detected by the temperature sensor.

8. The fuel cell system according to claim 1, wherein
the electronic control unit sets the limit value to be smaller as the oxygen partial pressure is lower based on the oxygen partial pressure or the oxygen partial pressure representative value detected by the oxygen partial pressure detection unit.
